(19) United States
(12) Patent Application Publication
(10) Pub. No.: US 2004/0100797 A1
(43) Pub. Date: May 27, 2004

(54) Lighting decoration device

(76) Inventor: Liang-Wei Yang, Taipei (TW)

Correspondence Address: SUPREME PATENT SERVICES, POST OFFICE BOX 2339, SARATOGA, CA, 95070, US

(21) Appl. No.: 10/303,431

(22) Filed: Nov. 23, 2002

(51) Int. Cl. F21S 13/14

(52) U.S. Cl. 362/252; 362/249; 362/240; 362/807; 362/121; 362/123

(57) ABSTRACT

A lighting device includes a base frame made of metal wires inside which lamps are arranged for giving off light. Acrylic filaments are attached to the frame by ejecting molten acrylic material over the frame whereby a transparent, arbitrarily-shaped, mesh-like jacket is formed around the frame. The light emitted from the lamps transmits through the acrylic filaments, inducing diffraction, reflection and refraction of the light inside the acrylic filaments to generate glory and dazzling over the frame.

### FIELD OF THE INVENTION

The present invention relates generally to a decoration device, such as a Christmas decoration, and in particular to a lighting decoration.

### BACKGROUND OF THE INVENTION

Lighting devices for decoration purposes are commonly known and widely used in celebration of holidays and festivals. One of the conventionally known lighting decorations comprises a frame, which may be formed in any desired shapes, such as a Christmas tree, a reindeer and a Santa Claus, and a lamp string wound around or otherwise attached to the frame. The lamp string comprises a number of lamps distributed in the frame whereby when the lamps are powered, light given off by the lamp illuminates the frame. Such a lighting decoration, however, emits plain light only. No glory and dazzling can be formed on the conventional lighting decoration. This makes it not appealing to the general consumers.

### SUMMARY OF THE INVENTION

Thus, an object of the present invention is to provide a lighting decoration that, when powered, gives off glorious and dazzling light.

Another object of the present invention is to provide a lighting decoration that forms a glorious appearance and is thus more appealing to the general consumers.

To achieve the above objects, in accordance with the present invention, there is provided a lighting device comprising a base frame made of metal wires inside which lamps are arranged for giving off light. Acrylic filaments are attached to the frame by ejecting molten acrylic material over the frame whereby a transparent, arbitrarily-shaped, mesh-like jacket is formed around the frame. The light emitted from the lamps transmits through the acrylic filaments, inducing diffraction, reflection and refraction of the light inside the acrylic filaments to generate glory and dazzling over the frame.

### BRIEF DESCRIPTION OF THE DRAWINGS

The present invention will be apparent to those skilled in the art by reading the following description of preferred embodiments thereof, with reference to the attached drawings, in which:

FIG. 1 is an exploded view of a lighting decoration device constructed in accordance with a first embodiment of the present invention;

FIG. 2 is a perspective view of a lighting decoration device constructed in accordance with a second embodiment of the present invention;

FIG. 3 is an exploded view of a lighting decoration device constructed in accordance with a third embodiment of the present invention;

FIG. 4 is a perspective view of a lighting decoration device constructed in accordance with a fourth embodiment of the present invention; and

FIG. 5 is a perspective view of a lighting decoration device constructed in accordance with a fifth embodiment of the present invention.

### DETAILED DESCRIPTION OF THE INVENTION

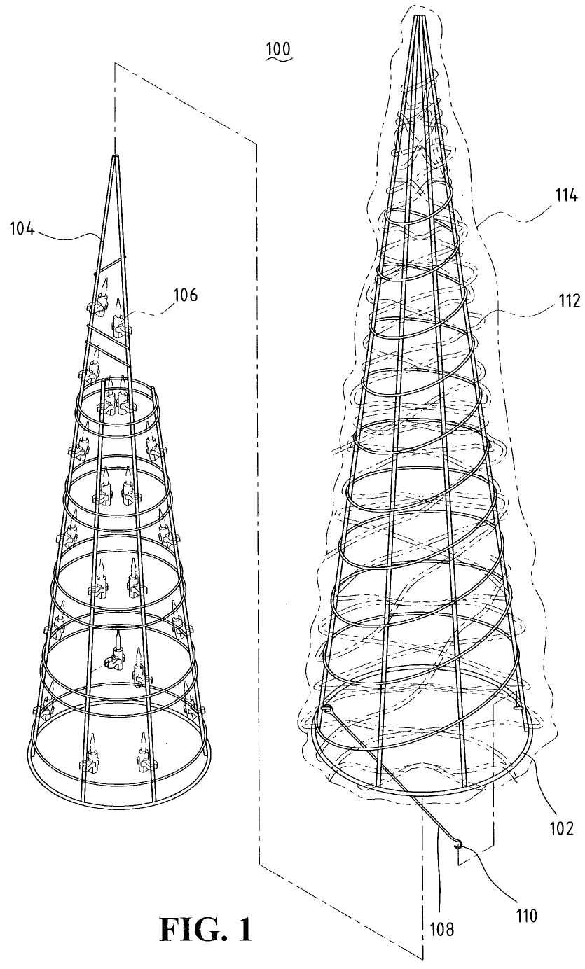

With reference to the drawings and in particular to FIG. 1, a lighting decoration device constructed in accordance with a first embodiment of the present invention, generally designated with reference numeral 100, comprises an outer frame 102 made of metal wires or bars in the form of a cone having an open bottom into which an inner frame 104, also in the form of a cone, is inserted. A number of lamps 106 are securely attached to the inner frame 104 and electrically connected to a power source by electrical wires (not shown). A retention bar 108 is attached to the bottom of the outer frame 102 for selectively retaining the inner frame 104 inside the outer frame 102. In the embodiment illustrated, the retention bar 108 has an end rotatably attached to an edge of the bottom opening of the outer frame 102 and an opposite end forming a hook 110 for releasably engaging an opposite edge of the bottom opening of the outer frame 102 to prevent the inner frame 104 from separating from the outer frame 102.

In accordance with the present invention, a plurality of transparent filaments 112 are wound around the outer frame 102 and entangle with each other to substantially comply with the outer contour of the outer frame 102. Openings (not shown) are formed between the filaments 112. Thus, the transparent filaments 112 form an arbitrarily-shaped mesh-like structure attached to the outer frame 102. If desired, a number of layers of the filament windings can be formed on the outer frame 102 and overlap each other. The light emitted from the lamps 106 of the inner frame 104 transmits through the transparent filaments 112 of different diameters or thickness before it reaches a viewer's eyes. Diffraction, reflection, and refraction of the light occur inside and the filaments 112 and thus leading to glory and dazzling for the outer frame 102.

An example of the transparent material of the filaments 112 is acrylic material. The acrylic material can be applied in molten form over the outer frame 112 by an ejecting device (not shown). Once it cures, a solid and hard filament is formed. The acrylic material can be repeatedly applied over the outer frame 102 to form a number of layers of filaments of different diameter or thickness. Thus, a transparent outer jacket 114 comprised several layers of transparent filaments 112 of different diameter or thickness is formed around the outer frame 102 that gives off a glorious light when the lamps 106 are turned on.

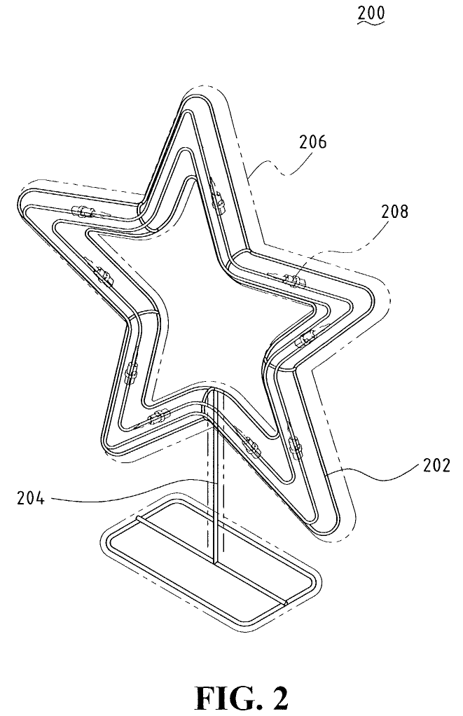

Referring to FIG. 2, a lighting decoration device constructed in accordance with a second embodiment of the present invention, generally designated with reference numeral 200, is shown. The lighting decoration device 200 comprises a frame 202 made of wires in the form of a star and a stand 204 also made of wires and integrated with the star frame 202 for supporting the star frame 202. Acrylic filaments are wound around the star frame 202 to form a mesh-like jacket 206 around the frame 202. Lamps 208 are attached to the frame 202 and are electrically connected to a power source by electrical wires (not shown) for powering the lamps 208. The lamps 208 give off light that transmitted through the acrylic filaments 206 for generating glorious and dazzling light around the frame 202.

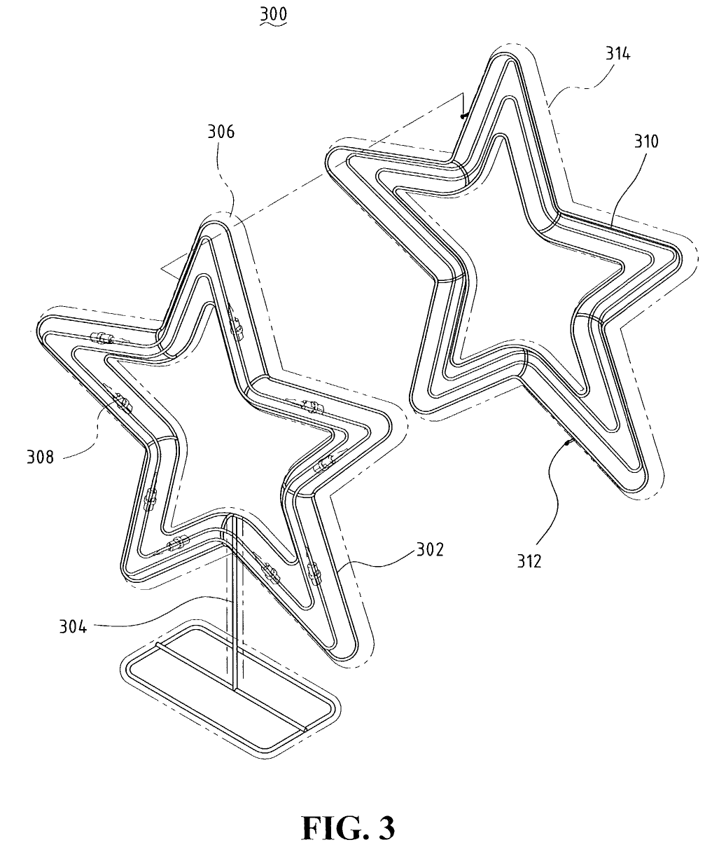

FIG. 3 shows a lighting decoration device constructed in accordance with a third embodiment of the present invention, generally designated with reference numeral 300. The lighting decoration device 300 is a modification of the lighting decoration device 200 with reference to FIG. 2, comprising a frame 302 made of wires in the form of a star and a stand 304 also made of wires and integrated with the star frame 302 for supporting the star frame 302. Acrylic filaments are wound around the star frame 302 to form a mesh-like jacket 306 around the frame 302. Lamps 308 are attached to the frame 302 and are electrically connected to a power source by electrical wires (not shown) for powering the lamps 308. A backside frame 310 is also made of wires in the form of a star that is complementary to the backside of the star frame 302 and is releasably mounted to the backside of the star frame 302 by means of fasteners 312. Similarly, an outer jacket 314 is formed over the backside frame 310 by attaching and entangling a plurality of acrylic filaments of different diameters and thickness to the backside frame 310. Light from the lamps 308 travels through the jackets 306, 314 of both star frames 302, 310 to glorify the star frames 306, 314.

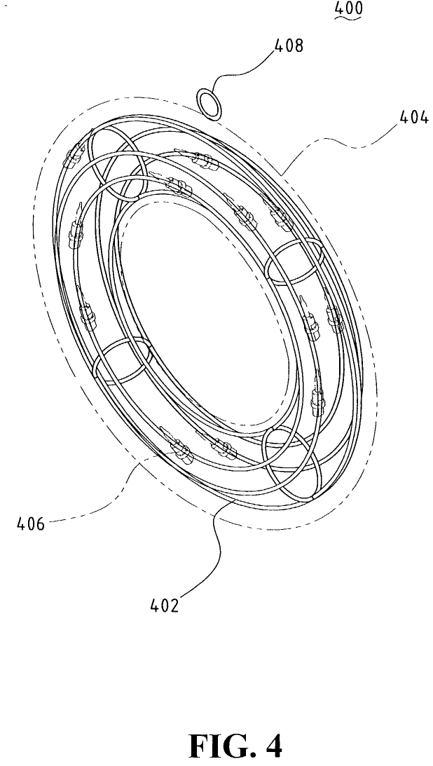

FIG. 4 shows a lighting decoration device constructed in accordance with a fourth embodiment of the present invention, generally designated with reference numeral 400. The lighting decoration device 400 comprises a donut-like frame 402 made of wires. Acrylic filaments are wound around the frame 402 to form a mesh-like jacket 404 around the frame 402. Lamps 406 are attached to the frame 402 and are electrically connected to a power source by electrical wires (not shown) for powering the lamps 406. The lamps 406 give off light that transmits through the acrylic filaments 404 for generating glorious and dazzling light around the frame 402. A hanging ring 408 is attached to the acrylic jacket 404 for hanging the lighting device 400 on a fixture, such as a tree and a wall.

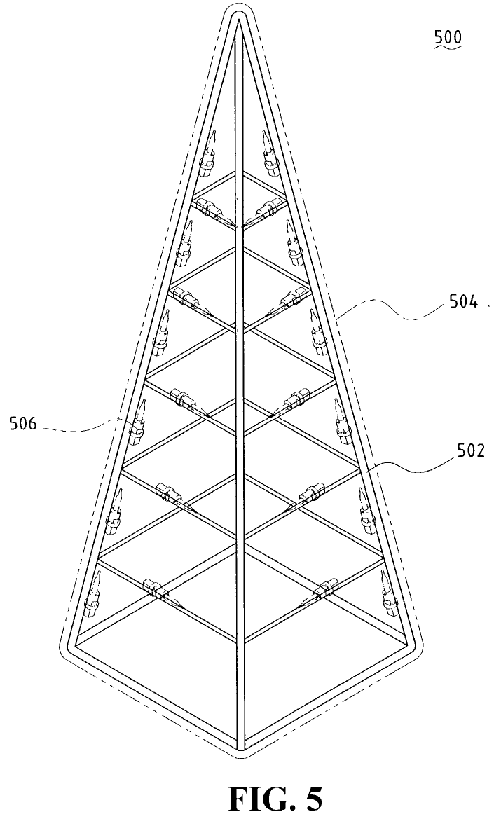

FIG. 5 shows a lighting decoration device constructed in accordance with a fifth embodiment of the present invention, generally designated with reference numeral 500, comprising a pyramidal frame 502 made of wires. The pyramidal frame 502 has a large bottom area that can be stably positioned on a surface of a fixture, such as desk. Acrylic filaments are wound around the frame 502 to form a mesh-like jacket 504 around the frame 502. Lamps 506 are attached to the frame 502 and are electrically connected to a power source by electrical wires (not shown) for powering the lamps 506. The lamps 506 give off light that transmits through the acrylic filaments 504 for generating glorious and dazzling light around the frame 502.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A lighting device comprising:
a base frame;
lamps arranged inside the base frame for giving off light; and
transparent filaments wound around and entangling each other over the base frame to form a transparent arbitrarily-shaped mesh-like jacket over the base frame.

2. The lighting device as claimed in claim 1, wherein the filaments are made of acrylic material.

3. The lighting device as claimed in claim 1, wherein the filaments are formed by ejecting and curing molten acrylic material over the base frame.

4. The lighting device as claimed in claim 1, further comprising a stand mounted to the base frame for supporting the frame.

5. The lighting device as claimed in claim 1, further comprising a hanging ring for hanging the base frame on a fixture.

6. The lighting device as claimed in claim 1, wherein the base frame has an open side to which a second frame is attached, and wherein transparent filaments are wound around and entangling each other over the second frame to form a transparent arbitrarily-shaped mesh-like jacket over the second frame.

7. The lighting device as claimed in claim 1, wherein the base frame has an opening through which a second frame is inserted, the lamps being secured on the second frame and thus positioned inside the base frame, securing means being provided on the base frame to retain the second frame inside the base frame.

8. The lighting device as claimed in claim 7, wherein the securing means comprises a bar having an end rotatably attached to one side of the base frame and an opposite end forming a hook for releasably engaging an opposite side of the base frame.

9. The lighting device as claimed in claim 1, wherein the frame is made in the form of a cone.

10. The lighting device as claimed in claim 1, wherein the frame is made in the form of a star.

11. The lighting device as claimed in claim 1, wherein the frame is made in the form a donut.

12. The lighting device as claimed in claim 1, wherein the frame is made in the form of a pyramid.
